(19) United States
(12) Patent Application Publication
(10) Pub. No.: US 2026/0030542 A1
(43) Pub. Date: Jan. 29, 2026

(54) MACHINE LEARNING MODEL REFRESH FRAMEWORK

(71) Applicant: PAYPAL, INC., San Jose, CA (US)

(72) Inventors: Mao Kang, Shanghai (CN); Lidong Ge, Shanghai (CN); Bingnan Wang, Shanghai (CN); Chen Chen, Shanghai (CN); Jiaqi Zhang, Shanghai (CN)

(21) Appl. No.: 18/784,250

(22) Filed: Jul. 25, 2024

(51) Int. Cl. G06N 20/00

(52) U.S. Cl. CPC G06N 20/00

(57) ABSTRACT

Methods and systems are presented for providing a machine learning model framework that provides an adaptive machine learning model base on providing quick and incremental trainings to the machine learning model. Instead of using the entire available training dataset to train the machine learning model, a subset of the available training dataset that accurately represents the characteristics of the training data set is extracted to be used in each iteration of incremental training. Furthermore, labels of unmatured dataset are imputed to provide additional training datasets that correspond to any emerging pattern. Synthetic training datasets are also generated to mimic datasets that correspond to an emerging pattern to strengthen the machine learning model's ability to recognize the emerging pattern.

### BACKGROUND

The present specification generally relates to a machine learning model framework, and more specifically, to providing an adaptive machine learning model based on incremental training according to various embodiments of the disclosure.

### RELATED ART

Machine learning models have been widely used to perform various tasks for different entities. For example, machine learning models may be used in classifying transactions (e.g., determining whether a transaction is a legitimate transaction or a fraudulent transaction, determining whether a transaction complies with a set of policies or not, etc.). To construct a machine learning model, a set of input features that are related to performing a task associated with the machine learning model are identified. Training data that is associated with the type of task to be performed by the machine learning model (e.g., historic transactions) can be used to train the machine learning model such that the machine learning model can learn various patterns associated with the training data and perform classification predictions based on the learned patterns.

While a machine learning model can be effective in learning patterns, the accuracy of its prediction is highly dependent on the quality of training data provided to the model. When new data that is fed to the machine learning model follows the pattens that were learned by the machine learning model during the training process, the machine learning model can perform the prediction task with an acceptable accuracy (e.g., above a threshold). On the other hand, when the new data does not follow the patterns that were learned by the machine learning model, the accuracy performance of the model may suffer. Since tactics in performing fraudulent transactions electronically are ever-evolving, fraudulent transactions may not always follow the same patterns. Thus, it is important that a machine learning model can quickly learn and adapt new patterns that emerge such that an acceptable accuracy performance of the model can be maintained. Conventionally, reconfigurations (e.g., modifying the input features, modifying parameters within the machine learning model, etc.) and retraining (e.g., using training data that corresponds to the newly emerged pattern, etc.) are often required to enable the machine learning model to classify transactions that correspond to new patterns. However, such a process often requires a substantial amount of computer resources and time (e.g., several days, several weeks, etc.) to complete. As a result, the adaptation of the machine learning models is often not quick enough to keep pace with the evolving fraud tactics, which can result in loss of funds for a user or merchant, exposure of personal data or information, and other adverse consequences of processing a fraudulent transaction. Thus, there is a need for a more efficient computer framework for reconfiguring and retraining machine learning models.

### BRIEF DESCRIPTION OF THE FIGURES

FIG. 1 is a block diagram illustrating an electronic transaction system according to an embodiment of the present disclosure;

FIG. 2 is a block diagram illustrating a classification module according to an embodiment of the present disclosure;

FIG. 3 illustrates an example data flow for generating training data for performing an incremental training for a machine learning model according to an embodiment of the present disclosure;

FIG. 4 illustrates an example data flow for performing an incremental training for a machine learning model according to an embodiment of the present disclosure;

FIG. 5 illustrates an example process for generating training data according to an embodiment of the present disclosure;

FIG. 6 illustrates an example process for performing an incremental training for a machine learning model according to an embodiment of the present disclosure;

FIG. 7 illustrates an example neural network that can be used to implement a machine learning model according to an embodiment of the present disclosure; and

FIG. 8 is a block diagram of a system for implementing a device according to an embodiment of the present disclosure.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

The present disclosure describes methods and systems for providing a machine learning model framework that enables a machine learning model to quickly adapt to any new and emerging patterns based on incremental training. As discussed herein, machine learning models have been used to classify data (e.g., determining whether a transaction is fraudulent or not, etc.). For example, computer-based machine learning models, such as artificial neural networks, gradient boosting trees, etc., may be configured to accept input values corresponding to a set of input features (e.g., attributes associated with a transaction), and to generate an output value that indicates a classification based on the input values. Through a training process, a machine learning model can “learn” to recognize patterns based on the training data (e.g., historic transactions, etc.), and use the learned patterns to classify new data (e.g., new transactions, etc.). As such, the machine learning model is capable of accurately (e.g., above an accuracy threshold) classifying the new data when the data follows the patterns that were recognized from the training data. When the new data does not follow the patterns, the machine learning model may not be capable of performing the classification task with the same accuracy performance.

Conventionally, in order for a classification system to adapt to newly emerging patterns (e.g., to learn and recognize the newly emerging patterns, etc.), the classification system may be required to generate a new machine learning model that is trained to recognize the newly emerging patterns, or reconfigure/retrain an existing machine learning model with additional training data. The classification system may be associated with a service provider, and may be configured to perform data transactions for the service provider. The classification system may obtain training data for training or retraining the machine learning model. For example, the classification system may obtain historical data (e.g., transaction data related to transactions conducted in the past, etc.). Due to the volume of transactions being conducted through a service provider, a large amount of transaction data (e.g., data related to hundreds of millions of transactions, etc.) may be available as training data for the classification system to train the machine learning model. Since a larger amount of training data typically provides better results than a smaller amount of training data, without knowing which portion of the training data corresponds to the newly emerging patterns, the entire training data is typically used for training the machine learning model. However, generating a new machine learning model and/or training a machine learning model using such a voluminous amount of training data may consume a substantial amount of computer processing power and time (e.g., it may take up to several days or several weeks to generate or reconfigure/retrain a machine learning model). The delay in adapting to the newly emerging patterns can have detrimental effects to the classification system (e.g., loss of data, reduction of efficiency as resources have been used in processing fraudulent transactions, etc.) and to the users (e.g., loss of data, loss of monetary values, etc.).

As such, according to various embodiments of the disclosure, the classification system may use the machine learning model framework as described herein, to provide quick and incremental improvements to one or more machine learning models such that the one or more machine learning models may incrementally adapt to newly emerging patterns in an efficient manner in terms of time and computer resources. In some embodiments, the classification system may provide frequent (e.g., weekly, bi-weekly, etc.) updates to an existing machine learning model.

In some embodiments, instead of using all of the available datasets (e.g., transaction data associated with historic transactions conducted through the online service provider and obtained by the classification system, etc.) as training data to train the machine learning model, the classification system may selectively use only a portion (e.g., a small portion) of the available datasets that accurately represents the available datasets to train the machine learning model to improve the efficiency of retraining the machine learning model. In order to identify a portion of the available datasets that accurately represents the available datasets, the classification system may identify different patterns that are represented by the available datasets, and extract sample datasets that represent each of the different patterns. In some embodiments, the classification system may use one or more clustering techniques (e.g., a k-means clustering technique, a DBSCAN clustering technique, a Gaussian Mixture Model clustering technique, etc.) to generate clusters of datasets (e.g., clusters of transactions) based on the attribute values associated with the different datasets. The different clusters may represent the different patterns (e.g., transaction patterns) that are associated with the available datasets.

The classification system may then extract sample datasets from each cluster. In some embodiments, when the classification system uses a centroid-based clustering technique to generate the clusters of datasets, the classification system may determine a centroid within each cluster. The classification system may then select, from the datasets within each cluster, a pre-determined number (e.g., 10, 100, 1,000, etc.) of datasets that are closest to the centroid of the cluster. Since the selected datasets include datasets that are from each of the clusters and that are closest to the centroid in each of the clusters, the selected datasets are representative of the different patterns associated with the available datasets. The classification system may use the selected datasets (instead of the entire available datasets) as training data to train the machine learning model. Using only the selected datasets to train the machine learning model may substantially reduce the amount of computer resources and time for retraining the machine learning model. Since the selected datasets include datasets that correspond to the different patterns associated with the available datasets, the machine learning model may still be trained to recognize the patterns even though only a portion of the available datasets is used as training data.

In some embodiments, the classification system may perform the incremental training of the machine learning model multiple times (e.g., iteratively, etc.) at different time instances. For example, the classification system may select different datasets from the available datasets as training data for training the machine learning model at each iteration. After selecting a first portion of the datasets and retraining the machine learning model using the first portion of the datasets, the classification system may select a second portion of the datasets (e.g., after waiting for a predetermined period of time from retraining the machine learning model using the first portion of the datasets). In some embodiments, the classification system may select the second portion of the datasets from the available datasets using a similar technique. For example, the classification system may select other datasets (that were not selected during the first iteration) within each cluster. The classification system may also select datasets that are closest to the centroid in each cluster (excluding the first portion of the datasets) to generate the second portion of datasets. The classification system may then retrain the machine learning model using the second portion of the datasets as training data. The classification system may continue to provide incremental training of the machine learning model using different portions of the available datasets that represent the different patterns over time (e.g., every two weeks, every month, etc.). Since the incremental retraining of the machine learning model requires much less computer resources and time than retraining the machine learning model in a conventional manner, the classification system may deploy a retrained machine learning model that has learned the newly emerging patterns for use in various classification tasks much quicker and consume fewer computing resources.

In some embodiments, in addition to selectively using different portions of training data for providing incremental training for the machine learning model, the classification system may also use various techniques to generate additional training data that would further enhance the ability of the machine learning model in adapting to emerging patterns. For example, the classification system may generate training data using unmatured data. In some embodiments, the available datasets (e.g., historical transaction data) may include matured data and unmatured data. Matured data is data where all of the attribute values (including the classification labels) are finalized (e.g., will not be modified anymore, the data is locked within the computer data structure, etc.), whereas unmatured data is data where some of the attribute values (e.g., the classification labels, etc.) are unavailable or can still be modified in the future. One example type of data that can include both matured data and unmatured data is data that describes chargeback transactions. Since a consumer can usually file a dispute to initiate a chargeback transaction within a certain period of time (e.g., 30 days, 60 days, etc.), the data associated with the underlying transactions may be unmatured during the period of time where disputes can still be initiated, as the chargeback attribute can still be changed during the period of time. The data may become mature when the period of time is over.

Due to the instability nature of unmatured data, unmatured data is typically excluded from being used for training a machine learning model. However, since the unmatured data includes the newest data from the available datasets, the unmatured data may be more representative of any emerging patterns than older data (e.g., includes more transactions that correspond to the emerging patterns, etc.). As such, the classification system may use various techniques to impute attribute values in the unmatured data before using the modified unmatured data as training data to retrain the machine learning model.

In some embodiments, the classification system may generate a knowledge library that includes data that correspond to a period of time and that has been labeled with a particular classification (e.g., transaction data of fraudulent transactions conducted over the past number of months or years, etc.). The classification system may compare the unmatured data against the data within the knowledge library. If it is determined that a dataset is similar to the data in the knowledge library (e.g., having attributes that are within a threshold of the attributes in the knowledge library, etc.), the classification system may assign the particular classification (e.g., fraudulent transactions, etc.) to the dataset as the classification label for the dataset.

In order to generate training data that is representative of the unmatured data, the classification system may also add additional datasets from the unmatured data that do not correspond to the data in the knowledge library. Since the additional datasets from the unmatured data do not correspond to the data in the knowledge library, the classification system may assign a different classification (e.g., non-fraudulent transactions, etc.) to the additional datasets as the classification labels to the additional datasets. In some embodiments, the classification system may include a number of additional datasets in the training data to maintain a particular ratio between the two classifications (e.g., 1:5, 1:10, 1:20, etc.). The particular ratio may correspond to a historic average ratio between transactions of the different classifications. The classification system may also retrain the machine learning model using the training data generated based on unmatured data (e.g., during each iteration, etc.).

In some embodiments, in addition to generating training data based on unmatured data, the classification system may also generate synthetic training data for retraining the machine learning model. For example, when the classification system detects a newly emerging pattern in new data, the classification system may generate additional synthetic data (that is artificially generated and not based on any actual real-life data) based on the new data. Since the emerging pattern is new, it is likely that only a small number of available datasets (e.g., below a threshold) corresponds to the emerging pattern. However, such a small number of available datasets may not be sufficient to effectively train the machine learning model (e.g., enabling the machine learning model to recognize the pattern, etc.). In order to strengthen the ability of the machine learning model to recognize the emerging pattern, additional datasets that follow the emerging pattern may be generated and used for retraining the machine learning model. For example, the classification system may identify the new datasets that follow the emerging pattern, and may adjust one or more attribute values in each of the new datasets slightly (e.g., within a predetermined range, etc.) to generate additional datasets. The synthetic datasets may be combined with the datasets that follow the emerging pattern to form training data for used by the classification system to retrain the machine learning model.

In some embodiments, the framework also provides a training methodology that uses one or more previous versions of the machine learning model to assist in the training of the machine learning model, such that knowledge from the one or more previous versions of the machine learning model can be distilled into the new machine learning model. As discussed herein, a machine learning model may undergo training incrementally. In some embodiments, the machine learning model may also undergo a more substantial modification, which may include a reconfiguration of the internal structure of the machine learning model (one or more modifications to the input nodes, one or more modifications to the hidden nodes, etc.). The substantial modifications to the machine learning model may occur less frequently than the incremental training, but may provide a more substantial improvement to the machine learning model than the incremental training. Each time the machine learning model undergoes a substantial modification, a new version of the machine learning model is generated. In some embodiments, the new version of the machine learning model may be a new model that is generated without inheriting any of the knowledge from the previous version(s) of the machine learning model (e.g., due to the modifications to the internal structure of the machine learning model, etc.). As such, in order for existing knowledge from one or more previous versions of the machine learning model to be transferred to the new machine learning model, the classification system may use the training methodology of the framework to train the new machine learning model.

Using the training methodology, training data may be provided to both the new machine learning model and one or more previous versions of the machine learning model. When a training dataset is fed into the new machine learning model, the output of the machine learning model may be compared with a label associated with the training dataset to generate a first loss value. The same training data set is also fed into each one of the one or more previous versions of the machine learning model. The outputs from each of the one or more previous versions of the machine learning model may also be compared to the label associated with the training dataset to generate second loss values. A combined loss can be generated based on the first loss value and the second loss values, and the combined loss (instead of the first loss value that is specifically associated with the new machine learning model) is then used to modify the new machine learning model through backpropagation.

By using the combined loss associated with both the previous versions of the machine learning model and the new machine learning model to perform backpropagation on the new machine learning model, the modifications provided to the new machine learning model through backpropagation may be adjusted (e.g., dampened, exaggerated, etc.) based on the performance (e.g., the knowledge) of the previous versions of the machine learning model. For example, the resulting combined loss may dampen the loss from the new machine learning model if the loss from the previous versions of the machine learning model is smaller than the loss from the new machine learning model (e.g., the previous versions of the machine learning model was more capable of classifying the dataset than the new machine learning model). On the other hand, the resulting combined loss may exaggerate the loss from the new machine learning model if the loss from the previous versions of the machine learning model is larger than the loss from the new machine learning model (e.g., the previous versions of the machine learning model was less capable of classifying the dataset than the new machine learning model). As a result, at least some of the knowledge from the previous versions of the machine learning model is transferred to the new machine learning model through this process.

Since the previous versions of the machine learning model can include models that have been generated and/or used during different time periods, and may be targeted for different trends/patterns, some of the previous versions of the machine learning model may be more accurate in performing classification on certain types of transactions than others. As such, in some embodiments, the classification system may provide a model to selectively use the outputs from some of the previous versions of the machine learning model (but not all outputs) to generate the combined loss for training the new machine learning model. In some embodiments, the model is also a machine learning model (e.g., an artificial neural network, etc.) that is trained to select the previous versions of the machine learning model based on characteristics of the training dataset. For example, the model may be trained to select the previous versions of the machine learning model that have an accuracy level in classifying transactions similar to the training dataset above a threshold. In some embodiments, the combined loss may also be used to further train the model configured to perform the output selection such that the selection performance can be continuously improved.

The techniques disclosed herein enable the classification system to provide improvements (e.g., through the incremental training process) to the machine learning model in an efficient manner, such that the machine learning model can be trained to recognize emerging patterns and deployed quickly.

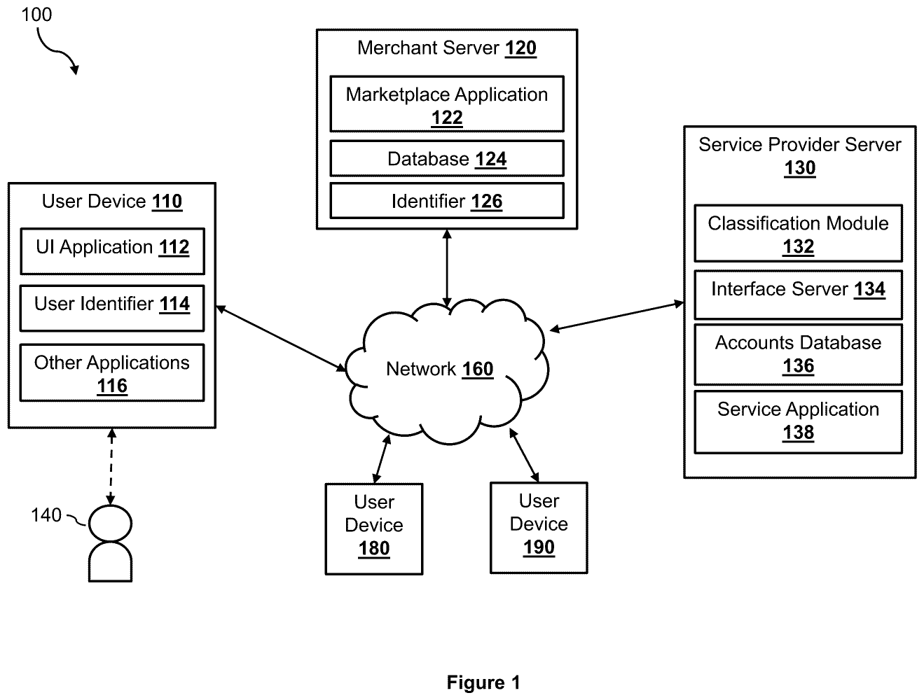

FIG. 1 illustrates an electronic transaction system 100, within which the machine learning model framework may be implemented according to one embodiment of the disclosure. The electronic transaction system 100 includes a service provider server 130 that is associated with an online service provider, a merchant server 120, and user devices 110, 180, and 190 that may be communicatively coupled with each other via a network 160. The network 160 may be implemented as a single network or a combination of multiple networks. For example, the network 160 may include the Internet and/or one or more intranets, landline networks, wireless networks, and/or other appropriate types of communication networks. In another example, the network 160 may comprise a wireless telecommunications network (e.g., cellular phone network) adapted to communicate with other communication networks, such as the Internet.

The user device 110 may be utilized by a user 140 to interact with the merchant server 120 and/or the service provider server 130 over the network 160. For example, the user 140 may use the user device 110 to conduct an online transaction with the merchant server 120 via websites hosted by, or mobile applications associated with, the merchant server 120. The user 140 may also log in to a user account to access account services or conduct electronic transactions (e.g., data access, account transfers or payments, onboarding transactions, etc.) with the service provider server 130. The user device 110 may be implemented using any appropriate combination of hardware and/or software configured for wired and/or wireless communication over the network 160. In various implementations, the user device 110 may include at least one of a wireless cellular phone, wearable computing device, PC, laptop, etc.

The user device 110, in one example, includes a user interface (UI) application 112 (e.g., a web browser, a mobile payment application, etc.), which may be utilized by the user 140 to interact with the merchant server 120 and/or the service provider server 130 over the network 160. In one implementation, the user interface application 112 includes a software program (e.g., a mobile application) that provides a graphical user interface (GUI) for the user 140 to interface and communicate with the service provider server 130 and/or the merchant server 120 via the network 160. In another implementation, the user interface application 112 includes a browser module that provides a network interface to browse information available over the network 160. For example, the user interface application 112 may be implemented, in part, as a web browser to view information available over the network 160. Thus, the user 140 may use the user interface application 112 to initiate electronic transactions with the merchant server 120 and/or the service provider server 130.

The user device 110 may include other applications 116 as may be desired in one or more embodiments of the present disclosure to provide additional features available to the user 140. In one example, such other applications 116 may include security applications for implementing client-side security features, programmatic client applications for interfacing with appropriate application programming interfaces (APIs) over the network 160, and/or various other types of generally known programs and/or software applications. In still other examples, the other applications 116 may interface with the user interface application 112 for improved efficiency and convenience.

The user device 110 may include at least one identifier 114, which may be implemented, for example, as operating system registry entries, cookies associated with the user interface application 112, identifiers associated with hardware of the user device 110 (e.g., a media control access (MAC) address), or various other appropriate identifiers. In various implementations, the identifier 114 may be passed with a user login request to the service provider server 130 via the network 160, and the identifier 114 may be used by the service provider server 130 to associate the user with a particular user account (e.g., and a particular profile).

Each of the user devices 180 and 190 may include similar hardware and software components as the user device 110, such that each of the user devices 180 and 190 may be operated by a corresponding user to interact with the merchant server 120 and/or the service provider server 130 in a similar manner as the user device 110.

The merchant server 120 may be maintained by a business entity (or in some cases, by a partner of a business entity that processes transactions on behalf of business entity). Examples of business entities include merchants, resource information providers, utility providers, online retailers, real estate management providers, social networking platforms, a cryptocurrency brokerage platform, etc., which offer various items for purchase and process payments for the purchases. The merchant server 120 may include a merchant database 124 for identifying available items or services, which may be made available to the user device 110 for viewing and purchase by the respective users.

The merchant server 120 may include a marketplace application 122, which may be configured to provide information over the network 160 to the user interface application 112 of the user device 110. The marketplace application 122 may include a web server that hosts a merchant website for the merchant. For example, the user 140 of the user device 110 may interact with the marketplace application 122 through the user interface application 112 over the network 160 to search and view various items or services available for purchase in the merchant database 124. The merchant server 120 may include at least one merchant identifier 126, which may be included as part of the one or more items or services made available for purchase so that, e.g., particular items and/or transactions are associated with the particular merchants. In one implementation, the merchant identifier 126 may include one or more attributes and/or parameters related to the merchant, such as business and banking information. The merchant identifier 126 may include attributes related to the merchant server 120, such as identification information (e.g., a serial number, a location address, GPS coordinates, a network identification number, etc.).

While only one merchant server 120 is shown in FIG. 1, it has been contemplated that multiple merchant servers, each associated with a different merchant, may be connected to the user devices 110, 180, and 190, and the service provider server 130 via the network 160.

The service provider server 130 may be maintained by a transaction processing entity or an online service provider, which may provide processing of electronic transactions between users (e.g., the user 140 and users of other user devices, etc.) and/or between users and one or more merchants. As such, the service provider server 130 may include a service application 138, which may be adapted to interact with the user device 110 and/or the merchant server 120 over the network 160 to facilitate the electronic transactions (e.g., electronic payment transactions, data access transactions, etc.) among users and merchants processed by the service provider server 130. In one example, the service provider server 130 may be provided by PayPal®, Inc., of San Jose, California, USA, and/or one or more service entities or a respective intermediary that may provide multiple point of sale devices at various locations to facilitate transaction routings between merchants and, for example, service entities.

The service application 138 may include a payment processing application (not shown) for processing purchases and/or payments for electronic transactions between a user and a merchant or between any two entities (e.g., between two users, between two merchants, etc.). In one implementation, the payment processing application assists with resolving electronic transactions through validation, delivery, and settlement. As such, the payment processing application settles indebtedness between a user and a merchant, wherein accounts may be directly and/or automatically debited and/or credited of monetary funds in a manner as accepted by the banking industry.

The service provider server 130 may also include an interface server 134 that is configured to serve content (e.g., web content) to users and interact with users. For example, the interface server 134 may include a web server configured to serve web content in response to HTTP requests. In another example, the interface server 134 may include an application server configured to interact with a corresponding application (e.g., a service provider mobile application) installed on the user device 110 via one or more protocols (e.g., RESTAPI, SOAP, etc.). As such, the interface server 134 may include pre-generated electronic content ready to be served to users. For example, the interface server 134 may store a log-in page and is configured to serve the log-in page to users for logging into user accounts of the users to access various service provided by the service provider server 130. The interface server 134 may also include other electronic pages associated with the different services (e.g., electronic transaction services, etc.) offered by the service provider server 130. As a result, a user (e.g., the user 140, or a merchant associated with the merchant server 120, etc.) may access a user account associated with the user and access various services offered by the service provider server 130, by generating HTTP requests directed at the service provider server 130.

The service provider server 130 may be configured to maintain one or more user accounts and merchant accounts in an accounts database 136, each of which may be associated with a profile and may include account information associated with one or more individual users (e.g., the user 140 associated with user device 110, users of the user devices 180 and 190, etc.) and merchants. For example, account information may include private financial information of users and merchants, such as one or more account numbers, passwords, credit card information, banking information, digital wallets used, or other types of financial information, transaction history, Internet Protocol (IP) addresses, device information associated with the user account. Account information may also include user purchase profile information such as account funding options and payment options associated with the user, payment information, receipts, and other information collected in response to completed funding and/or payment transactions.

In one implementation, a user may have identity attributes stored with (such as within accounts database 136) or accessible by the service provider server 130, and the user may have credentials to authenticate or verify identity with the service provider server 130. User attributes may include personal information, including photos, date of birth, social security number, home address, banking information and/or funding sources. In various aspects, the user attributes may be passed to the service provider server 130 as part of a login, search, selection, purchase, and/or payment request, and the user attributes may be utilized by the service provider server 130 to associate the user with one or more particular user accounts maintained by the service provider server 130 and used to determine the authenticity of a request from a user device.

When a user (e.g., the user 140) conducts a transaction with the merchant server 120 and/or the service provider server 130, the service provider server 130 may obtain attributes associated with the transaction. The attributes may be obtained from the user device 110 (e.g., a location of the device, an Internet Protocol (IP) address associated with the device, a device identifier, a browser type used by the device to conduct the transaction, an operating system type running on the device, etc.). The attributes may also be obtained from the user 140 via the user device 110 (e.g., the user providing a transaction amount of the transaction, the user providing user information of the user, etc.). For each transaction conducted via the service provider server 130, the service provider server 130 may store transaction data (which may include the attributes associated with the transaction) for future usage, for example, in the accounts database 136.

In various embodiments, the service provider server 130 also includes a classification module 132 that implements the machine learning model framework as discussed herein. In some embodiments, the classification module 132 may be configured to classify transactions conducted by various users (e.g., the user 140, the users of the user devices 180 and 190, etc.) with the merchant server 120 and/or the service provider server 130 using the techniques and the machine learning model framework disclosed herein. The transactions may include different types of transactions such as onboarding transactions (e.g., signing up for a new account), purchase transactions, payment transactions, chargeback transactions, credit application transactions, data access transactions, etc. Based on the classification determined for a transaction, the classification module 132 and/or the service application 138 may perform one or more actions associated with the transaction and/or the account that initiated the transaction. For example, the classification module 132 and/or the service application 138 may authorizing the processing of the transaction, deny the processing of the transaction, request additional data from a user, such as authentication data, and/or restricting the account (e.g., suspend the account, reduce the access level of one or more functionalities for the account, etc.).

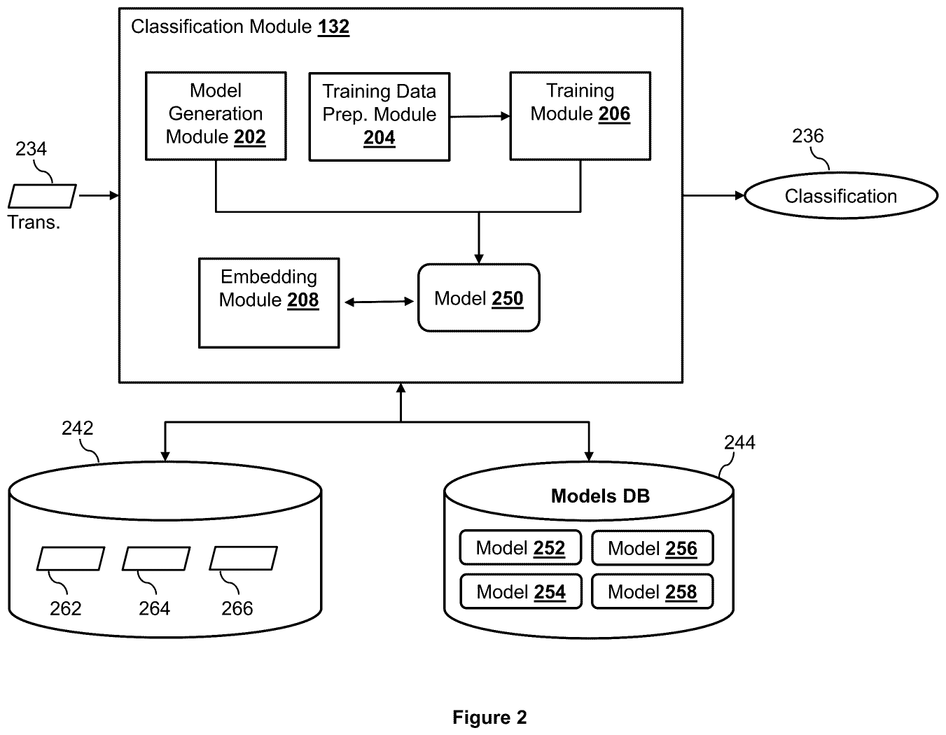

FIG. 2 is a block diagram illustrating the classification module 132 according to various embodiments of the disclosure. As shown, the classification module 132 includes a model generation module 202, a training data preparation module 204, a training module 206, an embedding module 208, and a model 250. The classification module 132 may receive transaction data associated with a transaction 234 (e.g., attributes of the transaction obtained from the interface server 134), and may use the model 250 to determine a classification 236 for the transaction 234. In some embodiments, the classification 236 may indicate whether the transaction 234 is a fraudulent transaction or a legitimate transaction. The classification module 132 may then perform an action to the transaction 234 based on the classification 236 and/or provide the classification 236 to another module (e.g., the service application 138) to perform an action to the transaction 234 or an account associated with the transaction 234.

In some embodiments, the model 250 may be implemented as a machine learning model (e.g., an artificial neural network, a gradient boosting tree, etc.), that includes a computer-based data structure and logic. In some embodiments, the classification module 132 may use the model generation module 202 to generate the model 250. For example, the model generation module 202 may generate a computer structure (e.g., inter-connecting nodes, etc.) that can receive input values corresponding to a set of input features. In some embodiments, the model generation module 202 may determine the set of input features for the model 250 based on a feature engineering process. For example, the model generation module 202 may evaluate different input feature candidates (e.g., a network address of a user device used to initiate the transaction, an amount of the transaction, a merchant type of a merchant, transaction history associated with a user who initiated the transaction, etc.) to select one or more input feature candidates as the input features for the model 250. The model generation module 202 may also generate other internal structures (e.g., hidden nodes) that are configured to manipulate the input values and to generate an output value (e.g., the classification 236). In some embodiments, the classification module 132 may also use the model training module 206 to perform an initial training of the model 250. The training process enables the model 250 to recognize patterns associated with previously conducted transactions, such that the model 250 can accurately predict classifications for new transactions based on the patterns. After training, the model 250 may be deployed to be used by the classification module 132 and the service provider server 130 to classify incoming transactions.

As discussed herein, fraudulent tactics may evolve over time, and fraudulent transactions using new tactics may not follow the same patterns as before. As such, as the fraudulent tactics evolve, the accuracy performance of the model 250 may be reduced if the model 250 does not adapt to the emerging fraud patterns (e.g., “learning” the new patterns through training or other means, etc.). Thus, according to various embodiments of the disclosure, the classification module 132 may perform incremental training to the model 250 according to the techniques disclosed herein, such that the model 250 can incrementally and efficiently learn the emerging patterns and use the emerging patterns to classify new transactions. In some embodiments, the training data preparation module 204 may access data that can potentially be used as training data for training the model 250. For example, the training data preparation module 204 may access transaction data associated with transactions conducted through the online service provider within a time period (e.g., the past 6 months, the past year, etc.) from the accounts database 136.

As the number of transactions conducted through the online service provider within the time period can be large (e.g., exceeding a threshold number, such as a hundred thousand, a million, a hundred million, etc.), using the transaction data associated with all of the accessed transactions to train the model 250 can take a substantial amount of computer processing resources and time, as discussed herein. In order to provide a more efficient way to train the model 250, the classification module 132 may provide incremental training to the model 250. Instead of training the model 250 using all of the available transaction data at once, the classification module 132 may use the training module 206 to use portions of the transaction data at a time to incrementally train the model 250.

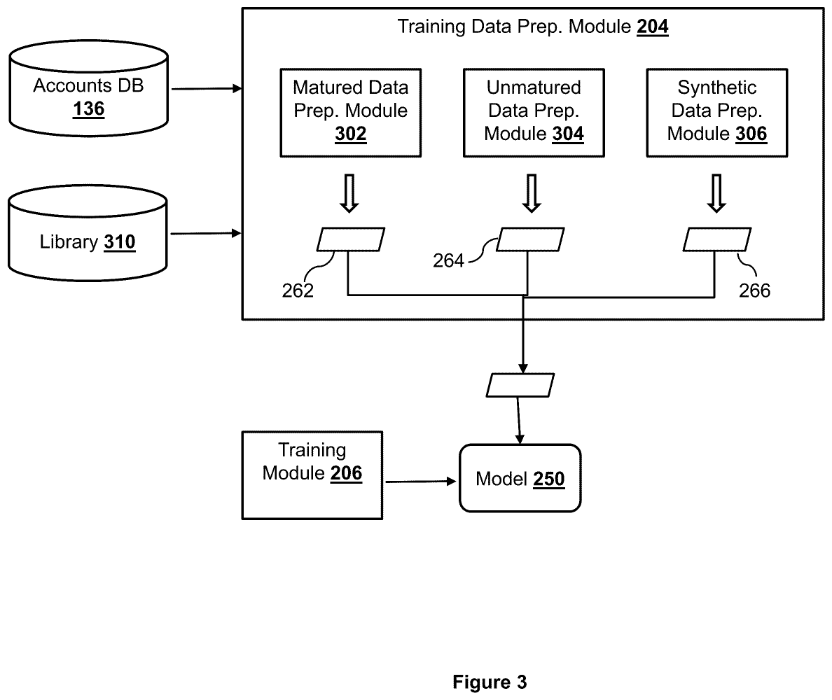

For example, the training data preparation module 204 may first access the available data (e.g., transaction data), which may include different datasets corresponding to different transactions. Each dataset may correspond to a distinct transaction and may include attributes associated with the transaction. The available datasets may include matured transaction data and unmatured transaction data. In some embodiments, the training data preparation module 204 may generate matured training datasets 262 based on the matured data, generate unmatured training datasets 264 based on the unmatured data, and generate synthetic training datasets 266 based on emerging patterns recognized by the classification module 132. The generation of the different training datasets will be discussed in more detail below by reference to FIG. 3. The training data preparation module 204 may store the matured training datasets 262, the unmatured training datasets 264, and the synthetic training datasets 266 in a data storage 242.

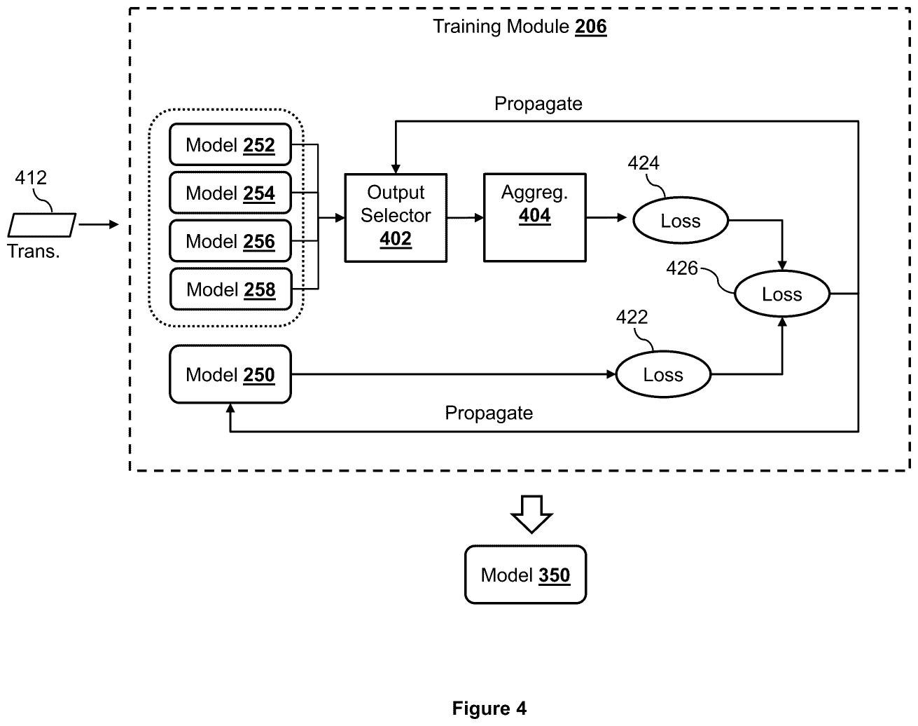

The training module 206 may then perform an incremental training for the model 250 based on the matured training datasets 262, the unmatured training datasets 264, and the synthetic training datasets 266 stored in the data storage 242. In some embodiments, the classification module 132 may use the training data preparation module 204 and the training module 206 to perform incremental training for the model 250 multiple times within a time period (e.g., periodically, upon a detection of an event, such as when a new pattern is detected, etc.). For example, the classification module 132 may use the training data preparation module 204 to generate a new set of training data based on the available data, and use the training module 206 to train the model 250. In some embodiments, the classification module 132 may use the model generation module 202 and/or the training module 206 to provide a more substantial improvement to the model 250. For example, the classification module 132 may use the model generation module 202 to generate a new model (e.g., a new version of the model 250) for performing the classification task. The new model may include a different internal computer structure as the model 250 (e.g., different input features, different hidden nodes, etc.). In some embodiments, the classification module 132 may perform the major upgrade to the model 250 less frequently than the incremental training to the model 250. As such, after generating multiple versions of the model 250, the classification module 132 may have one or more previous versions of the model 250, such as models 252, 254, 256, and 258. The classification module 132 may store these models in the models database 244, and may use these models to assist in the incremental training of the model 250, as will be discussed in more detail below by reference to FIG. 4.

FIG. 3 illustrates an example data flow for generating training data for incremental training of a machine learning model according to various embodiments of the disclosure. As shown, the training data preparation module 204 includes a matured data reparation module 302, an unmatured data preparation module 304, and a synthetic data preparation module 306. As discussed herein, the training data preparation module 204 may retrieve transaction data associated with transactions conducted through the online service provider over a time period from the accounts database 136. In some embodiments, the transaction data may include matured data and unmatured data. Matured data is data where all of the attribute values, including data that can be used as a classification label, are finalized (e.g., will not be modified anymore, such as when the data is locked or fixed, etc.), whereas unmatured data is data where some of the attribute values, such as the data that can be used as a classification label, can still be modified in the future. One example type of data that can include both matured data and unmatured data is data that describes chargeback transactions. Since a consumer can usually file a dispute to initiate a chargeback transaction within a certain period of time (e.g., 30 days, 60 days, etc.), the data associated with the underlying transactions may be unmatured during the period of time where disputes can still be initiated, as the chargeback attribute can still be changed during the period of time. The data may become mature when the period of time is over. Another example of this type of data are data associated with purchases since, like chargebacks, the purchase may not be final (e.g., not eligible for a return) until a certain period of time has passed or an event has occurred, such as the purchase being consumed.

In some embodiments, the matured data preparation module 302 may generate matured training data 262 for the model 250 based on the matured data. Since the matured data corresponds to transactions conducted with the online service provider over a long period of time, the matured data can include a large amount of data (e.g., exceeding a size threshold), such that training a machine learning model with all of the matured data would result in a substantial consumption of computer resources and time. In some embodiments, in order to improve the efficiency in performing the incremental training of the model 250, the matured data preparation module 302 may attempt to select a subset of the available data that is substantially smaller in size than the available data (e.g., 1/10, 1/100, 1/1000 of the size of the available data, etc.) and that would accurately represent the available data. In this regard, the matured data preparation module 302 may identify different patterns that are represented by the available datasets (where each dataset corresponds to a different transaction), and extract sample datasets that represents each of the different patterns. In some embodiments, the matured data preparation module 302 may use one or more clustering techniques (e.g., a k-means clustering technique, a DBSCAN clustering technique, a Gaussian Mixture Model clustering technique, etc.) to generate clusters of datasets (e.g., clusters of transactions) based on the attribute values associated with the different datasets. The different clusters may represent the different patterns (e.g., transaction patterns) that are associated with the available datasets.

The matured data preparation module 302 may then extract sample datasets from each cluster. In some embodiments, when the matured data preparation module 302 uses a centroid-based clustering technique to generate the clusters of datasets, the matured data preparation module 302 may determine a centroid within each cluster. The matured data preparation module 302 may then select, from the datasets within each cluster, a pre-determined number (e.g., 10, 100, 1,000, etc.) of datasets that are closest to the centroid of the cluster. Since the selected datasets include datasets that are from each of the clusters and that are closest to the centroid in each of the clusters, the selected datasets are representative of the different patterns associated with the available datasets. The matured data preparation module 302 may use the selected datasets (instead of the entire available datasets) as matured training data 252 for training the model 250. Using only the selected datasets to train the model 250 may substantially reduce the amount of computer resources and time for retraining the model 250. Since the matured training data 262 include datasets that correspond to the different patterns associated with the available datasets, the model 250 may still be trained to recognize the patterns even using only a portion of the available datasets as training data.

Due to the instability nature of unmatured data, unmatured data is typically excluded from being used for training a machine learning model. However, since the unmatured data includes the newest data from the available datasets, the unmatured data may be more representative of any emerging patterns than older data. As such, the unmatured data preparation module 304 may use various techniques to impute attribute values in the unmatured data, such that the unmatured data can be used as training data for retraining the model 250.

In some embodiments, the unmatured data preparation module 304 may access a library 310 that includes transaction data that corresponds to a period of time and that has been labeled with a particular classification (e.g., transaction data of fraudulent transactions conducted over the past number of months or years, etc.). The unmatured data preparation module 304 may compare the unmatured data against the data within the library 310. If it is determined that a dataset is similar to the data in the knowledge library (e.g., having attributes that are within a threshold of the attributes in the knowledge library, etc.), the unmatured data preparation module 304 may assign the particular classification (e.g., fraudulent transactions, etc.) to the dataset.

In order to generate training data that is representative of the unmatured data, the unmatured data preparation module 304 may also add additional datasets that do not correspond to the data in the library 310. Since the additional datasets do not correspond to the data in the library 310, the unmatured data preparation module 304 may assign a different classification (e.g., non-fraudulent transactions, etc.) to the additional datasets. In some embodiments, the unmatured data preparation module 304 may include a number of additional datasets in the training data to maintain a particular ratio between the two classifications (e.g., 1:5, 1:10, 1:20, etc.). The particular ratio may correspond to an average ratio between transactions of the different classifications. The unmatured data preparation module 304 may then combine the datasets that correspond to the data in the library 310 and the additional datasets as the unmatured training data 264.

In some embodiments, in addition to generating the matured training data 262 and the unmatured training data 264, the synthetic data preparation module 306 may also generate synthetic training data for retraining the model 250. For example, when the classification module 132 detects a newly emerging pattern in new transaction data and there is insufficient transaction data that corresponds to the emerging pattern, the synthetic data preparation module 306 may generate additional synthetic data (that is artificially generated and not based on any actual real-life data) based on the new data. Since the emerging pattern is new, there may be only a small number of datasets (e.g., below a threshold) that follow the emerging pattern. In order to improve the ability of the model 250 to recognize the emerging pattern, additional datasets that follow the emerging pattern may be generated by the synthetic data preparation module 306 and used for retraining the model 250. For example, the synthetic data preparation module 306 may identify the new datasets that follow the emerging pattern, and may adjust one or more attribute values in each of the new datasets slightly (e.g., within a predetermined range, etc.) to generate additional datasets. The synthetic datasets may be combined with the datasets that follow the emerging pattern to form the synthetic training data 266 for used to retrain the model 250.

The training module 206 may then use the matured training data 262, the unmatured training data 264, and the synthetic training data 266 to train the model 250. In some embodiments, the training data preparation module 204 may iteratively select different datasets from the available datasets as training data for training the model 250. For example, after selecting a first portion of the datasets and retraining the model 250 using the first portion of the datasets, the training data preparation module 204 may select and/or generate a second portion of the datasets (e.g., after waiting for a predetermined period of time from retraining the machine learning model using the first portion of the datasets) using similar techniques as disclosed herein. Specifically, the training data preparation module 204 may select other datasets (that were not selected during the first iteration) within each cluster. The training data preparation module 204 may also select datasets that are closest to the centroid in each cluster (excluding the first portion of the datasets) to generate the second portion of datasets. In some embodiments, the second portion of the data sets may include all three different training data types (e.g., matured training data, unmatured training data, and synthetic data, etc.) or include only some of the training data types. The training module 206 may then retrain the model 250 using the second portion of the datasets as training data. The classification module 132 may continue to provide incremental training of the model 250 using different portions of the available datasets that represent the different patterns over a period of time (e.g., every two weeks, every month, etc.). Since the incremental retraining of the model 250 requires much less computer resources and time than retraining the model 250 in a conventional manner, the classification module 132 may deploy a retrained model 250 for use in various classification tasks much quicker.

Referring back to FIG. 2, in some embodiments, the classification module 132 may perform a major modification to the model 250 after performing a number of incremental retraining iterations. For example, the classification module 132 may detect that the accuracy performance of the model 250 falls below a threshold, even after the incremental retraining. It is possible that the internal structure of the model 250 limits the performance of the model 250. As such, the classification module 132 may use the model generation module 202 to generate a new model (e.g., a new version of the model) for performing the classification task. The new model may include different internal computer structures (e.g., different input features, different hidden nodes, different connections among the nodes, etc.). After generating the new model, the training module 206 may train the new model using existing training data. When a few versions of the machine learning model have been generated over time, the classification module 132 may have a collection of previous versions of models, such as models 252, 254, 256, and 258. In some embodiments, the classification module 132 may use the previous models 252, 254, 256, and 258 to assist in the incremental retraining of the model 250.

FIG. 4 illustrates a training methodology usable to perform incremental retraining of machine learning models according to various embodiments of the disclosure. As shown in FIG. 4, the training module 206 includes an output selector 402 and an aggregator 404. To train the model 250, the training module 206 may iteratively feed different training datasets (e.g., corresponding to different transactions) to the model 250. For example, the training module 206 may feed dataset 412 to the model 250. The dataset 412 may correspond to a transaction that was conducted through the online service provider in the past, and may include attribute values associated with the transaction. The training module 206 may identify one or more attribute values that correspond to the input features of the model 250, and provide the one or more attribute values to the model 250. The model 250 is configured to generate an output (e.g., a predicted classification of the transaction) based on the dataset 412. The output may be compared against a label associated with the dataset 412 (indicating an actual classification of the transaction associated with the dataset 412) to generate a loss 422.

In some embodiments, the training module 206 may also feed the dataset 412 to the models 252, 254, 256, and 258. The models 252, 254, 256, and 258 may be previous versions of the model 250, and have been decommissioned. However, through this training process, the knowledge acquired by the models 252, 254, 256, and 258 may be effectively transferred to the model 250. Each of the models 252, 254, 256, and 258 may produce a respective output (e.g., predicted classifications of the transaction) based on the dataset 412. In some embodiments, the aggregator 404 may aggregate the outputs from the models 252, 254, 256, 258 (e.g., generating a mean, an average, etc.), and may generate a loss 424 based on the outputs from the models 252, 254, 256, 258. The training module 206 may then generate a combined loss 426 (e.g., taking an average, a weighted average, etc.) between the loss 422 and the loss 424. The training module 206 may then use the combined loss 426 (and not the loss 422) to modify the model 250 through backpropagation. By using the combined loss 426, instead of the loss 422, to perform backpropagation for the model 250, the model 250 not only learns the pattern based on the training data (e.g., the dataset 412), but also learns the knowledge from the models 252, 254, 256, and 258.

In some embodiments, the training module 206 may determine that some, but not all, of the previous models 252, 254, 256, and 258 are more accurate in classifying the transaction associated with the dataset 412 than the others. As such, in some embodiments, the output selector 402 may select some of the outputs from the models 252, 254, 256, and 258 for training the model 250. For example, the output selector may exclude an outlier output in the outputs generated by the models 252, 254, 256, and 258. In some embodiments, the output selector 402 is a machine learning model that is configured to predict which models have high accuracy (e.g., above a threshold) in classifying a transaction based on the transaction dataset 412. The output selector 402 may select different model(s) for use to generate the loss 424 for different training dataset based on the attribute values in the training dataset. As such, in some embodiments, the training module 206 may also use the combined loss 426 to retrain the output selector 402 to continue to improve the performance of the output selector 402.

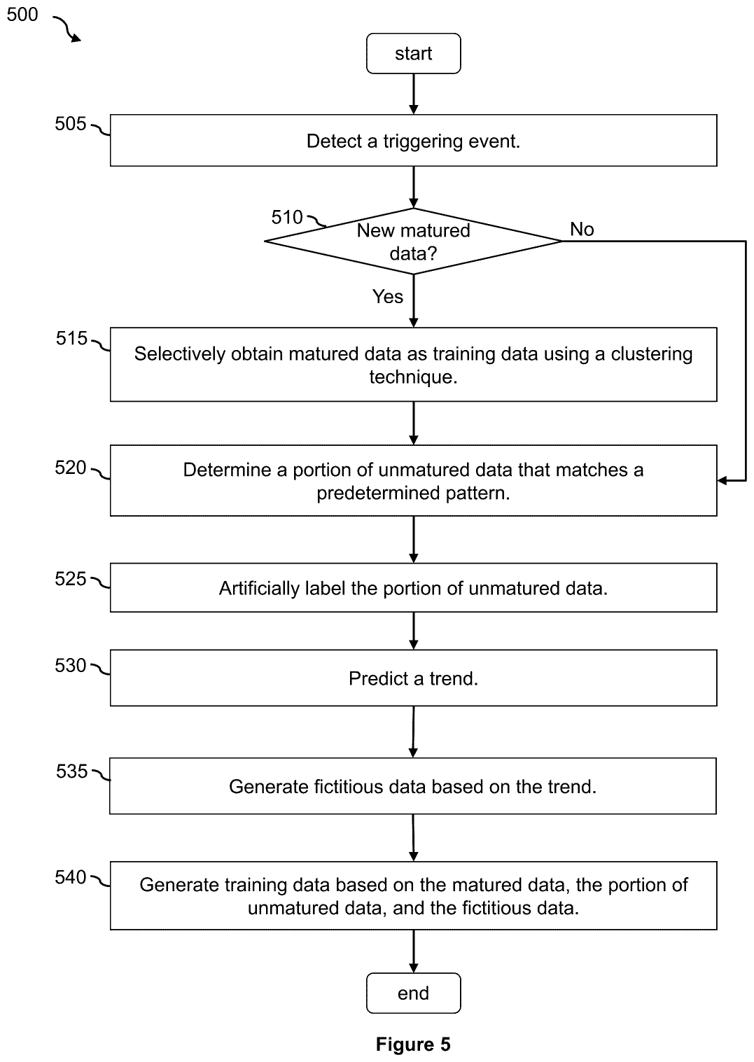

FIG. 5 illustrates a process 500 for generating training data for incremental training according to various embodiments of the disclosure. In some embodiments, at least a portion of the process 500 may be performed by the classification module 132. The process 500 begins by detecting (at step 505) a triggering event. For example, the classification module 132 may determine whether a condition for performing an incremental retraining of the model 250 exists. The condition can be associated with different criteria, such as an accuracy performance of the model 250, any new fraud trend detected, etc.

The process 500 then determines (at step 510) whether new matured data is available. If new matured data is available, the process 500 selectively obtains (at step 515) matured data as training data using a clustering technique. Matured data includes data (e.g., transaction data corresponding to different transactions) where all of the attribute values are unmodifiable (e.g., locked within a data structure, etc.). For example, matured data may include transaction data of transactions that have been conducted more then a time period ago (e.g., 30 days, 60 days, etc.) such that a chargeback request can no longer be initiated for those transactions. The matured data preparation module 302 may use a clustering technique to determine different patterns associated with the matured data, which corresponds to different clusters. The matured data preparation module 302 may select a subset of datasets from each cluster (e.g., the ones that are closest to the centroid of each cluster, etc.) as matured training data.

If new matured data is not available, the process 500 determines (at step 520) a portion of unmatured data that matches a predetermined pattern, and artificially labels (at step 525) the portion of unmatured data. For example, the unmatured data preparation module 304 may compare unmatured data against a library of historic data that has been labeled with a particular classification (e.g., fraudulent transactions). The unmatured data preparation module 304 may identify a first portion of the unmatured data that matches a pattern associated with the library of historic data, and may assign the particular classification to the first portion of the unmatured data. In some embodiments, the unmatured data preparation module 304 may also obtain a second portion of the unmatured data that does not match the pattern, may assign a different classification (e.g., non-fraudulent transactions) to the second portion of the unmatured data. The unmatured data that has been assigned (e.g., imputed) with classification labels will then be used as unmatured training data for training the model 250.

The process 500 also predicts (at step 530) a trend, and generates (at step 535) fictitious data based on the trend. For example, the synthetic data preparation module 306 may determine a trend of fraud tactics (e.g., an emerging trend) based on recently conducted transactions. However, since the trend is new, there might not be sufficient transactions that follow the trend for use as training data. As such, the synthetic data preparation module 306 may artificially generate additional data that follows the emerging trend as synthetic training data. For example, the synthetic data preparation module 306 may adjust one or more attribute values of the datasets that follow the emerging trend, and label them with the particular classification (e.g., fraudulent transactions).

The process 500 then generates (at step 540) training data based on the matured data, the portion of unmatured data, and the fictitious data. For example, the training data preparation module 204 may generate training data for training the model 250 by combining the matured training data, the unmatured training data, and the synthetic training data.

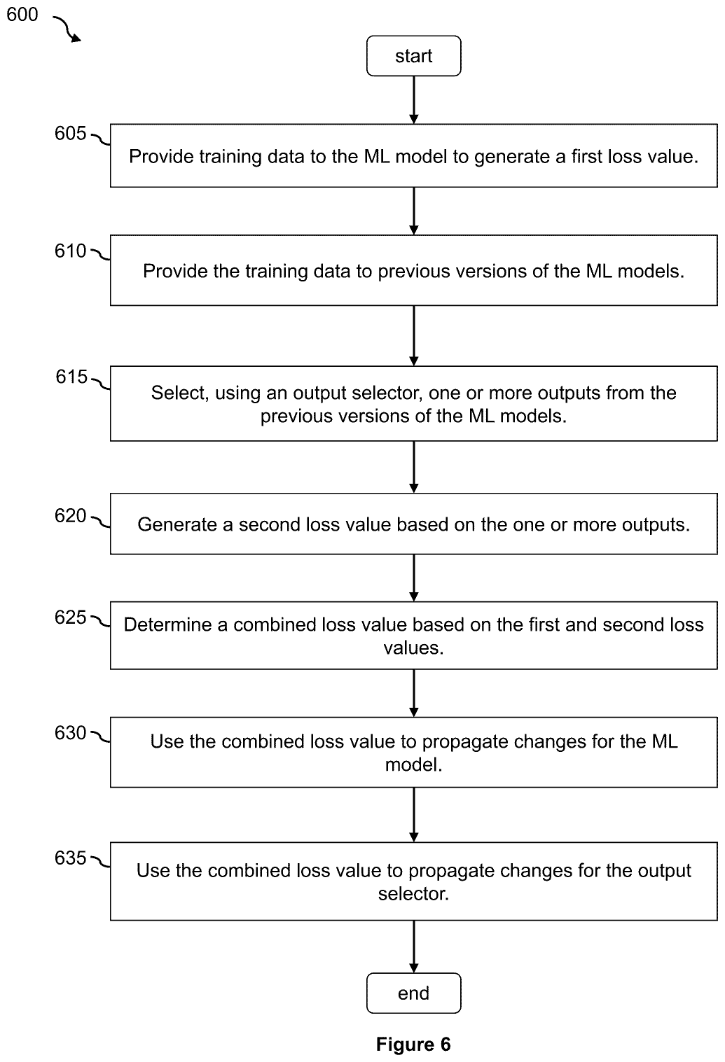

FIG. 6 illustrates a process 600 for performing an incremental training to a machine learning model according to various embodiments of the disclosure. In some embodiments, at least a portion of the process 600 may be performed by the classification module 132. The process 600 begins by providing (at step 605) training data to the ML model to generate a first loss value. For example, the training module 206 may provide training dataset 412 associated with a transaction to the model 250. By comparing an output from the model 250 and a label associated with training dataset 412, the training module 206 may generate a loss 422.

The process 600 also provides (at step 610) the training data to previous versions of the ML models, selects (at step 615), using an output selector, one or more outputs from the previous versions of the ML models, and generates (at step 620) a second loss value based on the one or more outputs. In addition to feeding the training dataset 412 to the model 250, the training module 206 also provides the training data set 412 to one or more of the models 252, 254, 256, and 258. Each of the models 252, 254, 256, and 258 may correspond to a previous version of the model 250, and may generate a respective output. The training module 206 may use the output selector 402 to select one or more outputs from the models 252, 254, 256, and 258 for use in training the model 250 based on the training dataset 412. The aggregator 404 may aggregate the selected outputs and generate a loss 424 based on comparing the aggregated output against the label associated with the training dataset 412.

The process 600 then determines (at step 625) a combined loss value based on the first and second loss values and uses (at step 630) the combined loss value to propagate changes to the ML model. For example, the training module 206 may generate a combined loss 426 based on the loss 422 and the loss 424, and may use the combined loss 426 to modify the model 250 through backpropagation.

The process 600 also uses (at step 635) the combined loss value to propagate changes for the output selector. In some embodiments, the output selector is a machine learning model configured to predict one or more models from the models 252, 254, 256, and 258 that can classify a given dataset with accuracy above a threshold. The combined loss 426 may also be used to train the output selector 402 such that the prediction performance of the output selector 402 can be continuously improved.

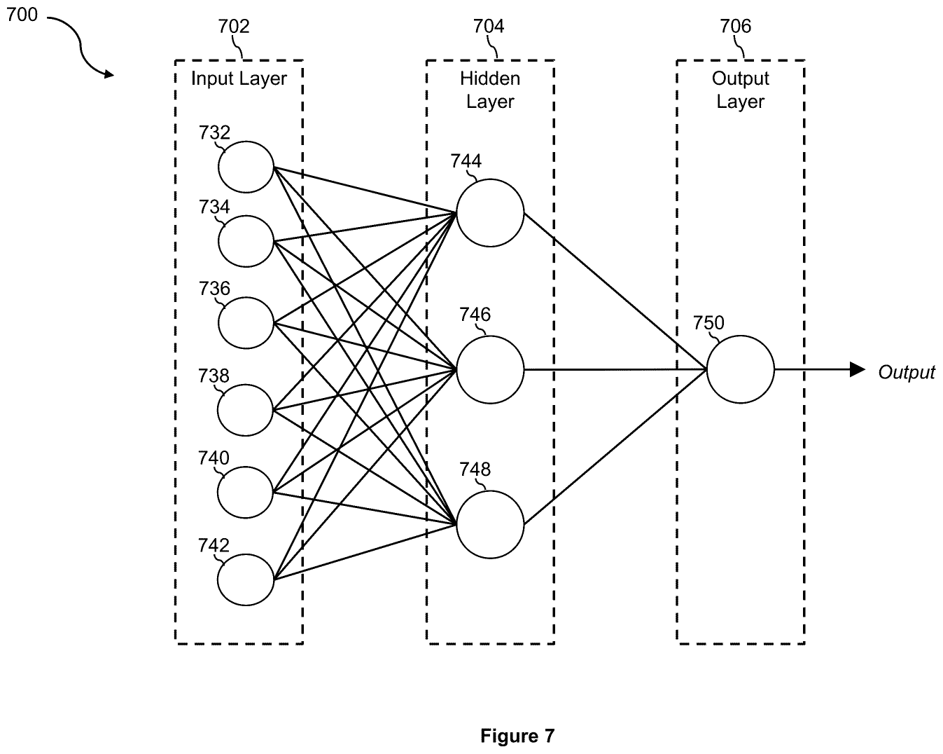

FIG. 7 illustrates an example artificial neural network 700 that may be used to implement a machine learning model, such as the model 250, the models 252, 254, 256, and 258, and the output selector 402. As shown, the artificial neural network 700 includes three layers-an input layer 702, a hidden layer 704, and an output layer 706. Each of the layers 702, 704, and 706 may include one or more nodes (also referred to as “neurons”). For example, the input layer 702 includes nodes 732, 734, 736, 738, 740, and 742, the hidden layer 704 includes nodes 744, 746, and 748, and the output layer 706 includes a node 750. In this example, each node in a layer is connected to every node in an adjacent layer via edges and an adjustable weight is often associated with each edge. For example, the node 732 in the input layer 702 is connected to all of the nodes 744, 746, and 748 in the hidden layer 704. Similarly, the node 744 in the hidden layer is connected to all of the nodes 732, 734, 736, 738, 740, and 742 in the input layer 702 and the node 750 in the output layer 706. While each node in each layer in this example is fully connected to the nodes in the adjacent layer(s) for illustrative purpose only, it has been contemplated that the nodes in different layers can be connected according to any other neural network topologies as needed for the purpose of performing a corresponding task.

The hidden layer 704 is an intermediate layer between the input layer 702 and the output layer 706 of the artificial neural network 700. Although only one hidden layer is shown for the artificial neural network 700 for illustrative purpose only, it has been contemplated that the artificial neural network 700 used to implement any one of the computer-based models may include as many hidden layers as necessary. The hidden layer 704 is configured to extract and transform the input data received from the input layer 702 through a series of weighted computations and activation functions.

In this example, the artificial neural network 700 receives a set of inputs and produces an output. Each node in the input layer 702 may correspond to a distinct input. For example, when the artificial neural network 700 is used to implement any one of the models 250, 252, 254, 256, and 258, the nodes in the input layer 702 may correspond to different attributes associated with a dataset (e.g., different attributes associated with a transaction, such as an amount, a network address of a device, etc.). When the artificial neural network 700 is used to implement the output selector, the nodes in the input layer 702 may also correspond to attributes associated with a dataset (e.g., different attributes associated with a transaction, such as an amount, a network address of a device, etc.).

In some examples, each of the nodes 744, 746, and 748 in the hidden layer 704 generates a representation, which may include a mathematical computation (or algorithm) that produces a value based on the input values received from the nodes 732, 734, 736, 738, 740, and 742. The mathematical computation may include assigning different weights (e.g., node weights, edge weights, etc.) to each of the data values received from the nodes 732, 734, 736, 738, 740, and 742, performing a weighted sum of the inputs according to the weights assigned to each connection (e.g., each edge), and then applying an activation function associated with the respective node (or neuron) to the result. The nodes 744, 746, and 748 may include different algorithms (e.g., different activation functions) and/or different weights assigned to the data variables from the nodes 732, 734, 736, 738, 740, and 742 such that each of the nodes 744, 746, and 748 may produce a different value based on the same input values received from the nodes 732, 734, 736, 738, 740, and 742. The activation function may be the same or different across different layers. Example activation functions include but not limited to Sigmoid, hyperbolic tangent, Rectified Linear Unit (ReLU), Leaky ReLU, Softmax, and/or the like. In this way, after a number of hidden layers, input data received at the input layer 702 is transformed into rather different values indicative data characteristics corresponding to a task that the artificial neural network 700 has been designed to perform.

In some examples, the weights that are initially assigned to the input values for each of the nodes 744, 746, and 748 may be randomly generated (e.g., using a computer randomizer). The values generated by the nodes 744, 746, and 748 may be used by the node 750 in the output layer 706 to produce an output value (e.g., a response to a user query, embeddings, a classification prediction, etc.) for the artificial neural network 700. The number of nodes in the output layer depends on the nature of the task being addressed. For example, in a binary classification problem, the output layer may consist of a single node representing the probability of belonging to one class. In a multi-class classification problem, the output layer may have multiple nodes, each representing the probability of belonging to a specific class. When the artificial neural network 700 is used to implement any one of the models 250, 252, 254, 256, and 258, the output node 750 may be configured to generate a binary classification (or a classification score) corresponding to whether a transaction is fraudulent or not. When the artificial neural network 700 is used to implement the output selector 402, the output node 750 may be configured to generate a prediction of one or more of the models 252, 254, 256, and 258 that can classify a given dataset with accuracy above a threshold.

In some examples, the artificial neural network 700 may be implemented on one or more hardware processors, such as CPUs (central processing units), GPUs (graphics processing units), FPGAs (field-programmable gate arrays), Application-Specific Integrated Circuits (ASICs), dedicated AI accelerators like TPUs (tensor processing units), and specialized hardware accelerators designed specifically for the neural network computations described herein, and/or the like. Example specific hardware for neural network structures may include, but not limited to Google Edge TPU, Deep Learning Accelerator (DLA), NVIDIA AI-focused GPUs, and/or the like. The hardware used to implement the neural network structure is specifically configured based on factors such as the complexity of the neural network, the scale of the tasks (e.g., training time, input data scale, size of training dataset, etc.), and the desired performance.

The artificial neural network 700 may be trained by using training data based on one or more loss functions and one or more hyperparameters. By using the training data to iteratively train the artificial neural network 700 through a feedback mechanism (e.g., comparing an output from the artificial neural network 700 against an expected output, which is also known as the “ground-truth” or “label”), the parameters (e.g., the weights, bias parameters, coefficients in the activation functions, etc.) of the artificial neural network 700 may be adjusted to achieve an objective according to the one or more loss functions and based on the one or more hyperparameters such that an optimal output is produced in the output layer 706 to minimize the loss in the loss functions. Given the loss, the negative gradient of the loss function is computed with respect to each weight of each layer individually. Such negative gradient is computed one layer at a time, iteratively backward from the last layer (e.g., the output layer 706 to the input layer 702 of the artificial neural network 700). These gradients quantify the sensitivity of the network's output to changes in the parameters. The chain rule of calculus is applied to efficiently calculate these gradients by propagating the gradients backward from the output layer 706 to the input layer 702.

Parameters of the artificial neural network 700 are updated backwardly from the last layer to the input layer (backpropagating) based on the computed negative gradient using an optimization algorithm to minimize the loss. The backpropagation from the last layer (e.g., the output layer 706) to the input layer 702 may be conducted for a number of training samples in a number of iterative training epochs. In this way, parameters of the artificial neural network 700 may be gradually updated in a direction to result in a lesser or minimized loss, indicating the artificial neural network 700 has been trained to generate a predicted output value closer to the target output value with improved prediction accuracy. Training may continue until a stopping criterion is met, such as reaching a maximum number of epochs or achieving satisfactory performance on the validation data. At this point, the trained network can be used to make predictions on new, unseen data, such as to determine classify a transaction, etc. For example, when the artificial neural network 700 is used to implement the model 250, the training data may include transaction data corresponding to transactions that have been previously processed, and labels indicating classifications of the transactions (e.g., whether the transactions are fraudulent or not, etc.).

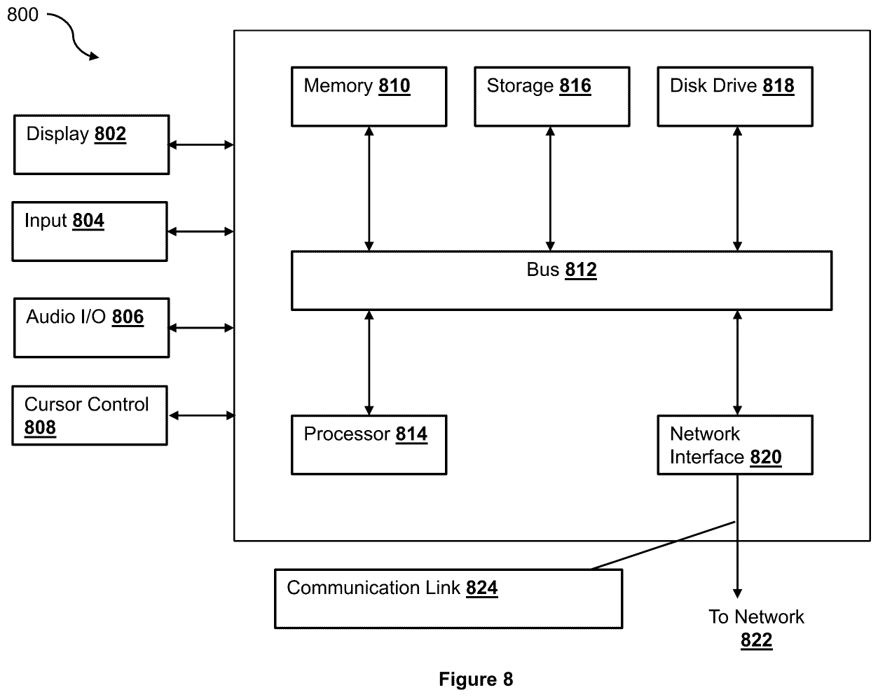

FIG. 8 is a block diagram of a computer system 800 suitable for implementing one or more embodiments of the present disclosure, including the service provider server 130, the merchant server 120, and the user devices 110, 180, and 190. In various implementations, each of the user devices 110, 180, and 190 may include a mobile cellular phone, personal computer (PC), laptop, wearable computing device, etc. adapted for wireless communication, and each of the service provider server 130 and the merchant server 120 may include a network computing device, such as a server. Thus, it should be appreciated that the devices 110, 120, 130, 180, and 190 may be implemented as the computer system 800 in a manner as follows.

The computer system 800 includes a bus 812 or other communication mechanism for communicating information data, signals, and information between various components of the computer system 800. The components include an input/output (I/O) component 804 that processes a user (i.e., sender, recipient, service provider) action, such as selecting keys from a keypad/keyboard, selecting one or more buttons or links, etc., and sends a corresponding signal to the bus 812. The I/O component 804 may also include an output component, such as a display 802 and a cursor control 808 (such as a keyboard, keypad, mouse, etc.). The display 802 may be configured to present a login page for logging into a user account or a checkout page for purchasing an item from a merchant. An optional audio input/output component 806 may also be included to allow a user to use voice for inputting information by converting audio signals. The audio I/O component 806 may allow the user to hear audio. A transceiver or network interface 820 transmits and receives signals between the computer system 800 and other devices, such as another user device, a merchant server, or a service provider server via a network 822. In one embodiment, the transmission is wireless, although other transmission mediums and methods may also be suitable. A processor 814, which can be a micro-controller, digital signal processor (DSP), or other processing component, processes these various signals, such as for display on the computer system 800 or transmission to other devices via a communication link 824. The processor 814 may also control transmission of information, such as cookies or IP addresses, to other devices.

The components of the computer system 800 also include a system memory component 810 (e.g., RAM), a static storage component 816 (e.g., ROM), and/or a disk drive 818 (e.g., a solid-state drive, a hard drive). The computer system 800 performs specific operations by the processor 814 and other components by executing one or more sequences of instructions contained in the system memory component 810. For example, the processor 814 can perform the machine learning model training functionalities described herein, for example, according to the processes 500 and 600.

Logic may be encoded in a computer readable medium, which may refer to any medium that participates in providing instructions to the processor 814 for execution. Such a medium may take many forms, including but not limited to, non-volatile media, volatile media, and transmission media. In various implementations, non-volatile media includes optical or magnetic disks, volatile media includes dynamic memory, such as the system memory component 810, and transmission media includes coaxial cables, copper wire, and fiber optics, including wires that comprise the bus 812. In one embodiment, the logic is encoded in non-transitory computer readable medium. In one example, transmission media may take the form of acoustic or light waves, such as those generated during radio wave, optical, and infrared data communications.

Some common forms of computer readable media include, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, or any other medium from which a computer is adapted to read.

In various embodiments of the present disclosure, execution of instruction sequences to practice the present disclosure may be performed by the computer system 800. In various other embodiments of the present disclosure, a plurality of computer systems 800 coupled by the communication link 824 to the network (e.g., such as a LAN, WLAN, PTSN, and/or various other wired or wireless networks, including telecommunications, mobile, and cellular phone networks) may perform instruction sequences to practice the present disclosure in coordination with one another.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The various features and steps described herein may be implemented as systems comprising one or more memories storing various information described herein and one or more processors coupled to the one or more memories and a network, wherein the one or more processors are operable to perform steps as described herein, as non-transitory machine-readable medium comprising a plurality of machine-readable instructions which, when executed by one or more processors, are adapted to cause the one or more processors to perform a method comprising steps described herein, and methods performed by one or more devices, such as a hardware processor, user device, server, and other devices described herein.

What is claimed is:

1. A system comprising:
a non-transitory memory; and
one or more hardware processors coupled with the non-transitory memory and configured to execute instructions from the non-transitory memory to cause the system to:
access a machine learning model that has been trained to classify transactions for a service provider using first training data;
obtain (i) a first plurality of transaction datasets corresponding to a first plurality of transactions conducted with the service provider over a first time period and (ii) a second plurality of transaction datasets corresponding to a second plurality of transactions conducted with the service provider over a second time period, wherein first verified labels associated with the first plurality of transaction datasets are available to the service provider, and wherein second verified labels associated with the second plurality of transaction datasets are unavailable to the service provider;
extract a first subset of the first plurality of transaction datasets using a clustering technique;
determine, from the second plurality of transaction datasets, a second subset of the second plurality of transaction datasets that match a transaction pattern derived from historic transactions with the service provider;
generate second training data for the machine learning model based on the first subset of the first plurality of transaction datasets and the second subset of the second plurality of transaction datasets; and
re-train the machine learning model using the second training data.

2. The system of claim 1, wherein extracting the first subset of the first plurality of transaction datasets comprises:
clustering the first plurality of transaction datasets into a plurality of clusters; and
extracting, from each corresponding cluster of the plurality of clusters, a corresponding portion of transaction datasets based on a centroid determined for the corresponding cluster.

3. The system of claim 2, wherein the corresponding portion of transaction datasets extracted from each corresponding cluster are within a threshold distance from the centroid determined for the corresponding cluster.

4. The system of claim 1, wherein executing the instructions further causes the system to:
predict a fraudulent transaction trend based on attributes associated with one or more transactions conducted with the service provider; and
generate a third plurality of transaction datasets based on the fraudulent transaction trend, wherein generating the second training data for the machine learning model is further based on the third plurality of transaction datasets.

5. The system of claim 4, wherein the third plurality of transaction datasets comprises fictitious transaction data.

6. The system of claim 1, wherein the machine learning model is a first machine learning model, and wherein re-training the machine learning model comprises:
obtaining a first loss value based on feeding a first transaction dataset to the first machine learning model;
obtaining a second loss value based on feeding the first transaction dataset to one or more second machine learning models;
calculating a combined loss value based on the first loss value and the second loss value; and
modifying one or more parameters of the first machine learning model based on the combined loss value.

7. The system of claim 6, wherein the one or more second machine learning models comprise a previous version of the first machine learning model.

8. A method, comprising:
obtaining, by a computer system, a first plurality of transaction datasets corresponding to a first plurality of transactions conducted with a service provider over a first time period;
extracting, by the computer system, a first subset of the first plurality of transaction datasets as first training data using a clustering technique;
obtaining, by the computer system, a second plurality of transaction datasets corresponding to a second plurality of transactions conducted with the service provider over a second time period, wherein labels associated with the second plurality of transaction datasets are unavailable to the service provider;
determining, from the second plurality of transaction datasets, a second subset of the second plurality of transaction datasets that match a transaction pattern derived from historic transactions with the service provider;
generating, by the computer system, second training data based on the second subset of the second plurality of transaction datasets, wherein the generating the second training data comprises assigning a first classification to the second subset of the second plurality of transaction datasets based on the determining that the second subset of the second plurality of transaction datasets matches the transaction pattern; and
training, by the computer system, the machine learning model using the first training data and the second training data.

9. The method of claim 8, wherein the generating the second training data is further based on a third subset of the second plurality of transaction datasets that does not match the transaction pattern, and wherein the generating the second training data further comprises assigning a second classification to the third subset of the second plurality of transaction datasets.

10. The method of claim 9, further comprising:
selecting, from the second plurality of transaction datasets, the third subset of the second plurality of transaction datasets based on a ratio between the second subset of the second plurality of transaction datasets and the third subset of the second plurality of transaction datasets.

11. The method of claim 8, wherein the machine learning model is a first machine learning model, and wherein the training the machine learning model comprises:
obtaining a first loss value based on feeding a first transaction dataset from the first training data or the second training data to the first machine learning model;
obtaining a second loss value based on feeding the first transaction dataset to one or more second machine learning models;
calculating a combined loss value based on the first loss value and the second loss value; and
modifying one or more parameters of the first machine learning model based on the combined loss value.

12. The method of claim 11, further comprising:
selecting, from the one or more second machine learning models, a subset of machine learning models based on historical performances of the one or more second machine learning models; and
generating the second loss value based on a set of output values from the subset of machine learning models.

13. The method of claim 8, wherein the extracting the first subset of the first plurality of transaction datasets comprises:
clustering the first plurality of transaction datasets into a plurality of clusters; and
extracting, from each corresponding cluster of the plurality of clusters, a corresponding portion of transaction datasets based on a centroid determined for the corresponding cluster.

14. The method of claim 13, wherein the corresponding portion of transaction datasets extracted from each corresponding cluster are within a threshold distance from the centroid determined for the corresponding cluster.

15. A non-transitory machine-readable medium having stored thereon machine-readable instructions executable to cause a machine to perform operations comprising:
obtaining a first plurality of transaction datasets corresponding to a first plurality of transactions conducted with a service provider over a first time period;
generating first training data based on a first subset of the first plurality of transaction datasets extracted from the first plurality of transaction datasets using a clustering technique;
obtaining a second plurality of transaction datasets corresponding to a second plurality of transactions conducted with the service provider over a second time period, wherein labels associated with the second plurality of transaction datasets are unavailable to the service provider;
determining, from the second plurality of transaction datasets, a second subset of the second plurality of transaction datasets that match a transaction pattern derived from historic transactions with the service provider;
generating second training data based on the second subset of the second plurality of transaction datasets, wherein the generating the second training data comprises assigning a first classification to the second subset of the second plurality of transaction datasets based on the determining that the second subset of the second plurality of transaction datasets matches the transaction pattern; and
training the machine learning model using the first training data and the second training data.

16. The non-transitory machine-readable medium of claim 15, wherein the generating the second training data is further based on a third subset of the second plurality of transaction datasets that does not match the transaction pattern, and wherein the generating the second training data further comprises assigning a second classification to the third subset of the second plurality of transaction datasets.

17. The non-transitory machine-readable medium of claim 16, wherein the operations further comprise:
selecting, from the second plurality of transaction datasets, the third subset of the second plurality of transaction datasets based on a ratio between the second subset of the second plurality of transaction datasets and the third subset of the second plurality of transaction datasets.

18. The non-transitory machine-readable medium of claim 15, wherein the machine learning model is a first machine learning model, and wherein the training the machine learning model comprises:
obtaining a first loss value based on feeding a first transaction dataset from the first training data or the second training data to the first machine learning model;
obtaining a second loss value based on feeding the first transaction dataset to one or more second machine learning models;
calculating a combined loss value based on the first loss value and the second loss value; and
modifying one or more parameters of the first machine learning model based on the combined loss value.

19. The non-transitory machine-readable medium of claim 18, wherein the one or more second machine learning models comprise a previous version of the first machine learning model.

20. The non-transitory machine-readable medium of claim 18, wherein the operations further comprise:
selecting, from the one or more second machine learning models, a subset of machine learning models based on historical performances of the one or more second machine learning models; and
generating the second loss value based on a set of output values from the subset of machine learning models.
